(19) United States
(12) Patent Application Publication
(10) Pub. No.: US 2004/0074144 A1
(43) Pub. Date: Apr. 22, 2004

(54) Hydrogen storage tank having a hydrogen absorbing alloy

(76) Inventors: Yoshihiro Isogai, Aichi (JP); Hidehito Kubo, Aichi (JP)

Correspondence Address: MORGAN & FINNEGAN, , L.L.P., 345 Park Avenue, New York, NY, 10154, US

(21) Appl. No.: 10/669,952

(22) Filed: Sep. 23, 2003

(30) Foreign Application Priority Data
Oct. 21, 2002 (JP) P2002-305592

(51) Int. Cl. B01J 8/00; F17B 1/00

(52) U.S. Cl. 48/174; 422/190; 422/198

(57) ABSTRACT

A hydrogen storage tank includes a housing, and a heat exchanger provided within the housing. The heat exchanger has an upstream side heat transfer pipe formed flatly, a downstream side heat transfer pipe formed flatly, and a connection pipe for connecting the two heat transfer pipes to each other. The heat exchanger has a plurality of fins which are formed between the two heat transfer pipes so as to extend along the lengthwise direction of the two heat transfer pipes. A composite of granular MH powder and flaky aluminum powder is stored in the housing in the condition that the composite is in contact with the two heat transfer pipes and the fins. For example, powder of a rare-earth alloy (MmNi5) having a particle size of not larger than 500 μm is used as the MH powder. For example, flaky aluminum powder having a mean particle size of 80 μm and a thickness of 0.5 μm to 2 μm is used as the flaky aluminum powder. The two kinds of powder are mixed so that the amount of the flaky aluminum powder is in a range of from 2% by volume to 11% by volume.

### BACKGROUND OF THE INVENTION

1. Field of the Invention

The present invention relates to a hydrogen storage tank and particularly to a hydrogen storage tank having a hydrogen absorbing alloy. The present invention also relates to a hydrogen absorbing alloy molded body including the hydrogen absorbing alloy.

2. Description of the Related Art

Hydrogen energy has attracted public attention as clean energy as well as solar heat energy. Use of a metal called “hydrogen absorbing alloy (hereinafter referred to as MH)” has attracted public attention as a method for storing and carrying hydrogen, because the MH is capable of absorbing hydrogen under a certain temperature and pressure condition, to thereby be hydrogenated and releasing hydrogen under another temperature and pressure condition when in use of the hydrogen. Investigation has been made into various techniques relating to the MH, such as hydrogen engine or a fuel cell powered car using MH for supplying hydrogen, and a heat pump using generation/absorption of heat at the time of absorbing/releasing hydrogen to/from MH.

When MH is used in a hydrogen storage container, the MH is generally used in a state in which the container, having a hydrogen gas intake port and a hydrogen gas outlet port, being filled with MH powder. Because large expansion/contraction occurs in MH at the time of absorption/release of hydrogen, MH has the property that the particle size of MH is reduced to a size of the order of several microns when absorption/release of hydrogen is repeated. Although MH high in hydrogen absorbing/releasing speed is practically advantageous, the hydrogenating reaction often progresses while the rate of the reaction is limited by heat transfer. Accordingly, when absorption/release of hydrogen needs to be increased, it is necessary to increase the heat transfer area, to thereby quicken removal and addition (supply) of heat of reaction. There is however a problem that the heat transfer efficiency of the hydrogen absorbing alloy layer is reduced remarkably to make the hydrogen absorbing/releasing speed slow as the particle size of MH is reduced. For example, the heat conductivity of a filler layer of MH fine powder shows a value of the order of hundreds of mW/(m·K), which is smaller by double figures than the heat conductivity of bulk MH.

Various methods have been proposed in the related art to prevent such reduction both in particle size of MH and in heat transfer efficiency of MH. For example, a hydrogen storage device in which flaky powder of MH and flaky powder of another metal than MH are mixed homogeneously has been proposed (see JP-A-11-116201, paragraph [0010] through [0012]). In the document JP-A-11-116201, Cu, Ni and Al have been listed as examples of the other metal. There has also been proposed, in JP-A-11-248097, an MH container having an airtight casing provided with hydrogen supplying/discharging ports thereon and contains hydrogen storing elements, and an outer surface of the casing is to be heated and cooled. The hydrogen storing elements disclosed in the document JP-A-11-248097 are made of porous metal molding material containing MH in voids thereof, and are accommodated in the casing in a manner that an outer surface thereof closely contacts to an inner surface of the casing (see JP-A-11-248097, paragraph [0011] through [0014]).

There has been further proposed a hydrogen absorbing electrode containing an electrically conducting agent, in which 10% by weight to 30% by weight of flaky nickel powder (having a mean particle size of 15 mm to 20 mm and a thickness of 1.0 mm to 1.1 mm) are added as the electrically conducting agent (see JP-A-4-262367, paragraph [0004] through [0005]).

There is a method in which powder of another metal is mixed with MH powder in order to make improvement against reduction in heat transfer efficiency caused by the smallness of the contact area between MH particles in the case where the container is filled with only MH powder. FIG. 8A typically shows the relation between MH powder and powder of another metal. In this case, the contact area between MH powder 30 and metal powder 31 increases to improve the heat transfer efficiency. Heat resistance, however, increases because of increase of the contact interface, so that the improvement of the heat transfer effect is not sufficient totally. FIG. 8B typically shows the relation between flaky MH powder 30 and flaky powder 31 of another metal in the hydrogen storage device described in the document JP-A-11-116201. In this case, the contact area between MH powder 30 and metal powder 31 increases more greatly to improve the heat transfer efficiency. Heat resistance, however, increases because of increase of the contact interface. Because the percentage of the metal powder 31 increases, there is a problem that the size of the container increases when the loading weight of the MH powder 30 is selected to be the same as described above. Because the MH powder 30 needs to be flaked, there is also a problem that the production cost increases and the particle size of the MH powder 30 is apt to be reduced because of repetition of absorption/release of hydrogen.

In the MH container described in the document JP-A-11-248097, large voids are required in consideration of filling the porous metal molding material with MH. It is difficult to provide a required minimum amount of the porous metal molding material as a heat conducting material. The skeleton of the porous metal molding material is so linear that the heat transfer area cannot be increased even in the case where the porous metal molding material is pressed. As a result, the heat transfer efficiency is insufficient.

The disclosure of the document JP-A-4-262367 aims at improving the electric conductive characteristic of the hydrogen absorbing electrode but gives no description to improvement in heat transfer of MH.

### SUMMARY OF THE INVENTION

It is therefore an object of the invention to provide a hydrogen storage tank high in hydrogen absorbing/releasing speed.

In order to achieve the above object, according to a first aspect of the invention, there is provided a hydrogen storage tank including: a housing; and a composite contained in the housing, the composite including a granular hydrogen absorbing alloy powder and a flaky metal powder.

According to the first aspect of the invention, because the granular hydrogen absorbing alloy powder (MH powder) is not flaky but granular, the percentage of the contact interface is reduced compared with the case where flaky MH powder is used. Accordingly, heat resistance of the contact interface is reduced totally to improve heat transfer efficiency.

In the first aspect of the invention, preferably, the housing may include a heat exchanger having fins, and the composite is accommodated in the housing to be in contact with the fins. In this configuration, because the composite of MH powder and flaky metal powder is also subjected to heat exchange through the fins of the heat exchanger, heat transfer performance is improved compared with the case where no fin is provided. Accordingly, the amount of absorbed/released hydrogen per unit time is increased.

In the first aspect of the invention, preferably, there includes a heat exchanger having a fin and a hydrogen absorbing alloy molded body molded out of a porous metal molding material (foamed metal) in which the composite is filled thereof, and the hydrogen absorbing alloy molded body is accommodated in the housing to be in contact with the fin. In this configuration, the composite can be stored in the housing easily with a good state of heat exchange due to the heat exchanger compared with the case where the vacant space provided in the heat exchanger is directly filled with the granular MH powder and the flaky metal powder.

### BRIEF DESCRIPTION OF THE DRAWINGS

The above objects and advantages of the present invention will become more apparent by describing preferred exemplary embodiments thereof in detail with reference to the accompanying drawings, wherein:

FIGS. 1A and 1B show a hydrogen storage tank according to a first embodiment of the invention, FIG. 1A being a sectional view taken along the line A-A in FIG. 1B, FIG. 1B being a sectional view taken along the line B-B in FIG. 1A;

FIG. 2 is a typical view showing the relation between MH powder and flaky aluminum powder;

FIG. 3 is a graph showing hydrogen filling characteristic;

FIG. 4 is a graph showing hydrogen filling characteristic;

FIG. 5A is a typical front view showing the relation between a heat exchanger and MH molded body in a second embodiment of the invention, and FIG. 5B is a side view of the heat exchanger;

FIG. 6 is a typical view of each of the MH molded body;

FIG. 7 is a typical sectional view of a hydrogen storage tank according to another embodiment of the invention; and

FIG. 8A is a typical view showing the relation between MH powder and powder of another metal, and FIG. 8B is a typical view showing the relation between flaky MH powder and flaky metal powder.

### DETAILED DESCRIPTION OF THE PREFERRED EMBODIMENTS

Referring now to the accompanying drawings, a description will be given in detail of preferred embodiments of the invention.

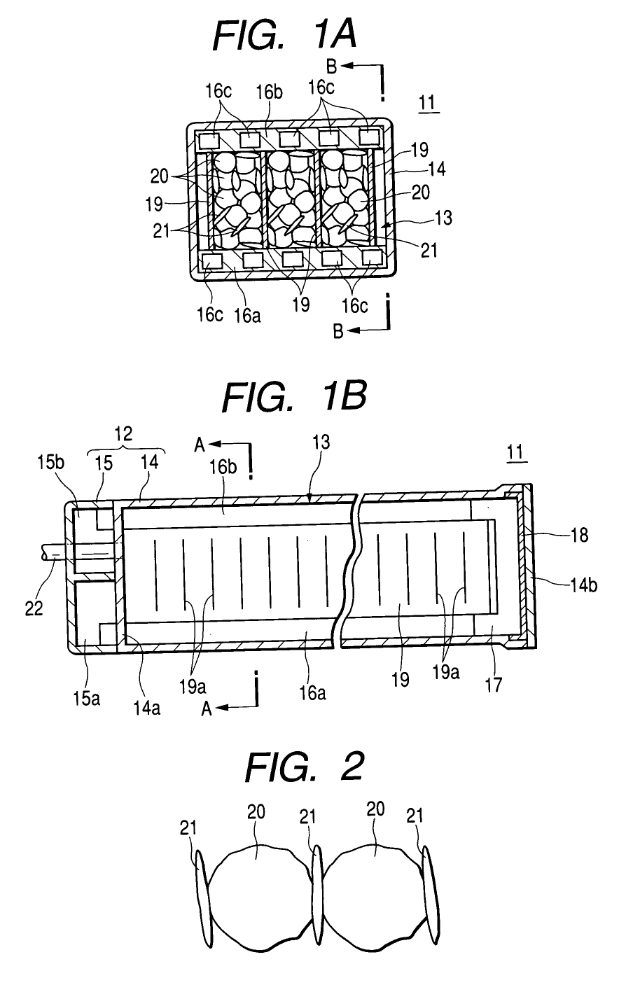

A first embodiment of the invention will be described below with reference to FIGS. 1A and 1B and FIGS. 2-4. FIG. 1A is a sectional view taken along the line A-A in FIG. 1B. FIG. 1B is a sectional view taken along the line B-B in FIG. 1A. FIG. 2 is a view typically showing the relation between granular (granulated) hydrogen absorbing alloy powder (MH powder) and flaky (flake-shaped) aluminum powder.

As shown in FIGS. 1A and 1B, a hydrogen storage tank 11 includes a housing 12 as a container, and a heat exchanger 13 provided within the housing 12. Incidentally, the top side in FIG. 1B is regarded as the top side of the hydrogen storage tank 11, and the left side in FIG. 1B is regarded as the front side of the hydrogen storage tank 11.

The housing 12 has a body 14, and a header 15 for supplying a heating medium (such as water, oil, or engine coolant) to the heat exchanger 13. The body 14 is shaped like a rectangular pipe having one end closed with a front wall 14a, and an opening side (rear side) closed with a cover portion 14b. The header 15 is shaped like a bottomed rectangular pipe having an opening side end portion fixed to an outer circumferential edge of the front wall 14a. The header 15 is partitioned into two chambers 15a and 15b. Each of the chambers 15a and 15b is connected to a heating medium piping not shown through a pipe, so that the heat medium is supplied from one chamber 15a and discharged from the other chamber 15b.

The heat exchanger 13 has an upstream side heat transfer pipe 16a formed flatly, a downstream side heat transfer pipe 16b formed flatly, and a connection pipe 17 for connecting the two heat transfer pipes 16a and 16b to each other. The two heat transfer pipes 16a and 16b and the connection pipe 17 are formed so as to be equal in thickness. The two heat transfer pipes 16a and 16b are disposed horizontally on upper and lower sides respectively so as to be symmetrical to each other with respect to an assumed plane containing the center of the housing 12 and extending horizontally. As shown in FIG. 1A, each of the two heat transfer pipes 16a and 16b has a large number of independent small flow paths 16c arranged laterally to form a row. The connection pipe 17 is fixed to the cover portion 14b of the body 14 through a bracket 18. Each of the upstream side heat transfer pipe 16a and the downstream side heat transfer pipe 16b has a first end portion, and a second end portion. The two heat transfer pipes 16a and 16b are disposed so that the first end portions are protruded into the chambers 15a and 15b respectively through holes formed in the front wall 14a, and the second end portions are connected to the connection pipe 17. That is, the heat exchanger 13 is formed so that the heating medium flows in the chamber 15a, the upstream side heat transfer pipe 16a, the connection pipe 17, the downstream side heat transfer pipe 16b and the chamber 15b successively.

The heat exchanger 13 has a plurality of fins 19 which are formed between the two heat transfer pipes 16a and 16b so as to extend along the lengthwise direction of the two heat transfer pipes 16a and 16b. As shown in FIG. 1A, the fins 19 are disposed opposite to the body 14 so that a gap is formed between each fin 19 and the wall surface of the body 14. As shown in FIG. 1B, the fins 19 are provided with a plurality of slits 19a. The width of each slit 19a is formed so as to be small enough to prevent passage of the MH powder 20 and the flaky aluminum powder 21.

A composite of the granular MH powder 20 and the flaky aluminum powder 21 is stored in the body 14 in the condition that the composite is in contact with the two heat transfer pipes 16a and 16b and the fins 19. As the MH powder 20, for example, powder of a rare-earth alloy (MmNi₅) having a particle size of not larger than 500 μm is used. As the flaky aluminum powder 21, for example, flaky aluminum powder having a mean particle size of 80 μm and a thickness in a range of from 0.5 μm to 2 μm is used. The two kinds of powder are mixed so that the amount of the flaky aluminum powder 21 is in a range of from 2% by volume to 11% by volume.

A pipe 22, which is aport for introducing/discharging hydrogen gas into/from the housing 12, is provided in the hydrogen storage tank 11. The pipe 22 is disposed so that the first end portion of the pipe 22 pierces the front wall 14a of the body 14 as well as the pipe 22 pierces the header 15.

The operation of the hydrogen storage tank 11 configured as described above will be described below taking the case of application of the hydrogen storage tank 11 to a fuel cell powered electric car as an example.

When hydrogen gas is used in a fuel electrode, hydrogen gas is released from the hydrogen storage tank 11 through the pipe 22 and supplied to the fuel electrode. When the hydrogen gas is released from the inside of the hydrogen storage tank 11, the hydrogen absorbing/releasing reaction of MH powder 20 shifts to the release side so that hydrogen gas is released from the MH powder 20. Because release of hydrogen is an endoergic reaction, MH consumes its own sensible heat and releases hydrogen to thereby decrease the temperature of MH if heat required for releasing hydrogen is not provided by-the heating medium. As the temperature of MH decreases, the rate of the hydrogen releasing reaction decreases. The heating medium with a predetermined temperature is, however, supplied into the chamber 15a of the header 15, so that the heating medium flows in the upstream side heat transfer pipe 16a of the heat exchanger 13, the connection pipe 17 of the heat exchanger 13, the downstream side heat transfer pipe 16b of the heat exchanger 13 and the chamber 15b successively. As a result, the MH powder 20 is heated to a predetermined temperature, so that the hydrogen releasing reaction progresses smoothly. The released hydrogen is released from the pipe 22 to the outside of the hydrogen storage tank 11 through a fine gap between the MH powder 20 and the aluminum powder 21 and supplied to the fuel electrode. While the rate of the reaction for releasing hydrogen from the MH powder 20 is controlled by the temperature of the heating medium, the temperature or flow rate of the heating medium is controlled so that the heating medium can be kept at such a predetermined temperature that the MH powder 20 gets into a state of hydrogen releasing reaction corresponding to the amount of hydrogen gas necessary for a fuel battery.

When the hydrogen storage tank 11 from which hydrogen has been released needs to be filled with hydrogen gas again, that is, when hydrogen gas needs to be absorbed to the MH powder 20, hydrogen gas is supplied into the hydrogen storage tank 11 through the pipe 22. The hydrogen gas supplied into the hydrogen storage tank 11 penetrates into the composite of MH powder 20 and aluminum powder 21 and reacts with the MH powder 20. The hydrogen gas is absorbed to the MH powder 20 as a hydride.

Because the hydrogen absorbing reaction is an exoergic reaction, the hydrogen absorbing reaction does not progress smoothly if heat generated in the hydrogen absorbing reaction is not removed. When the hydrogen storage tank 11 needs to be filled with hydrogen gas, the heating medium with a low temperature is supplied to the header 15 so that heat generated in the MH powder 20 is transported to the outside of the hydrogen storage tank 11 by the fins 19 and the heating medium flowing in the heat transfer pipes 16a and 16b of the heat exchanger 13. Accordingly, the MH powder 20 can be kept at a temperature required for smooth progress of the hydrogen absorbing reaction, so that absorption of hydrogen gas is performed efficiently.

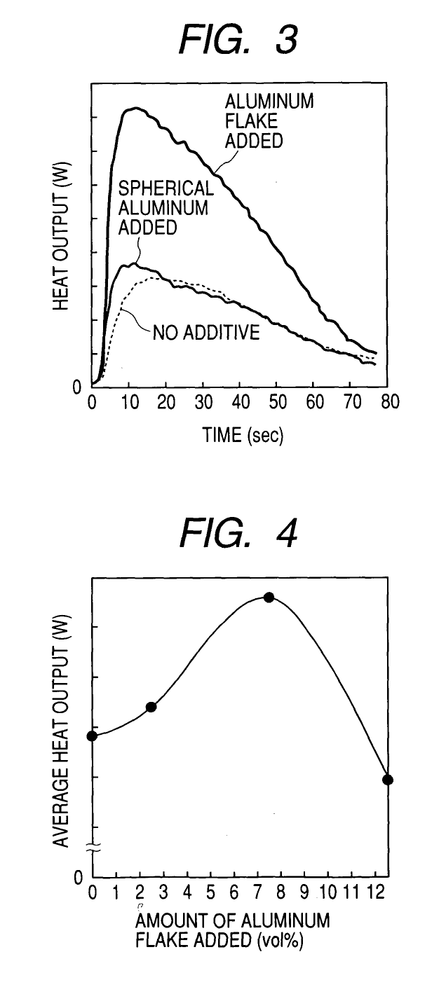

In the hydrogen storage tank 11 having the heat exchanger 13 configured as described above, 250 g of a composite consisting of MH powder 20 and 7.5% by volume of flaky aluminum powder 21 were stored to evaluate the hydrogen filling characteristic. The hydrogen filling characteristic was evaluated as follows. The hydrogen storage tank 11 in which the composite was stored was. subjected to an activating process sufficiently by repetition of evacuation and hydrogen pressurization. Then, in the condition that hydrogen was supplied into the hydrogen storage tank 11 through the pipe 22 while the inlet temperature of the heating medium was kept constant, the outlet temperature of the heating medium was measured to thereby calculate the change of the heat output with the passage of time on the heat medium side. FIG. 3 shows results of the measurement.

As a comparative example, 250 g of a composite of MH powder 20 and 7.5% by volume of spherical (sphere-shaped) aluminum powder 21 as a substitute for the flaky aluminum powder 21 were stored in the hydrogen storage tank 11 having the heat exchanger 13 configured as described above. As another comparative example, 250 g of MH powder 20 without aluminum powder 21 mixed with MH powder 20 were stored in the hydrogen storage tank 11 having the heat exchanger 13 configured as described above. The hydrogen filling characteristic of each comparative example was evaluated likewise.

As shown in FIG. 3, the heat output in the case where spherical aluminum powder 21 was added as a heat transfer assisting material was improved by about 10% compared with that in the case where the heat transfer assisting material was not mixed. On the other hand, the heat output in the case where flaky aluminum powder 21 was added as a heat transfer assisting material was improved to twice or more compared with that in the case where the transfer assisting material was notadded.

In addition, while the amount (composite percentage) of added flaky aluminum powder 21 was changed, the average heat output was measured. FIG. 4 shows results of the measurement. As shown in FIG. 4, the average heat output varied according to the amount of the flaky aluminum powder 21 added. The average heat output was maximized at about 7.5% by volume of the added flaky aluminum powder 21. Accordingly, the amount of added flaky aluminum powder 21 is selected to be preferably in a range of from 2% by volume to 11% by volume, further preferably in a range of from 3.5% by volume to 10% by volume.

The reason why the heat output increases, that is, the rate of the hydrogen absorbing reaction becomes high when flaky aluminum powder 21 is mixed with (added into) the granular MH powder 20 in the aforementioned manner will be conceived on the basis of the relation between the MH powder 20 and the flaky aluminum powder 21 as typically shown in Fig. 2. Each particle of the flaky aluminum powder 21 is sandwiched between particles of granular MH powder 20, so that the contact area between the MH powder 20 and the flaky aluminum powder 21 increases greatly compared with the case where particles of the aluminum powder 21 are spherical. If the MH powder 20 is also flaky as described in the document JP-A-11-116201, the number of particles of the MH powder 20 received in a predetermined volume increases to thereby increase the number of contact interfaces between the MH powder 20 and the flaky aluminum powder 21. When the MH powder 20 is formed in a granular shape, the number of contact interfaces however decreases and, furthermore, heat resistance of the contact interfaces is reduced compared with that in the case where particles of the MH powder 20 are in contact with one another. For the two reasons, heat transfer efficiency is greatly improved.

The aforementioned first embodiment has the following advantages.

(1) The hydrogen storage tank 11 is formed so that the composite of granular MH powder 20 and flaky aluminum powder 21 is stored in the housing 12. Accordingly, because the MH powder 20 is not flaky but granular, the percentage of the contact interfaces is reduced compared with that in the case where the MH powder 20 is flaky. Accordingly, total heat resistance of the contact interfaces is reduced to improve heat transfer efficiency. As a result, the hydrogen absorbing speed is improved, so that the time required for filling the hydrogen storage tank 11 with hydrogen can be shortened. In addition, the hydrogen releasing speed is improved, so that the hydrogen releasing response of the hydrogen storage tank 11 can be quickened. The amount of MH powder 20 allowed to be filled in a predetermined volume increases compared with that in the case where the MH powder 20 is flaky. Accordingly, the amount of hydrogen gas stored per unit volume increases, so that the number of miles of the car driven by hydrogen gas filled once can be increased when the hydrogen storage tank 11 is applied to a fuel cell powered car.

(2) The housing 12 includes the heat exchanger 13 having fins 19. The composite is stored in the housing 12 in the condition that the composite is in contact with the fins 19. The composite of MH powder 20 and flaky aluminum powder 21 can be also subjected to heat exchange through the fins 19 of the heat exchanger 13. Accordingly, heat transfer performance is improved compared with that in the case where no fin 19 is provided. Accordingly, the amount of hydrogen absorbed/released per unit time increases.

(3) The fins 19 are disposed opposite to the body 14 so that a gap is formed between each fin 19 and the wall surface of the body 14. In addition, the fins 19 are provided with a plurality of slits 19a, so that the gap between each fin 19 disposed opposite to the body 14 and the wall surface of the body 14 serves as a hydrogen path when the hydrogen is absorbed/released to/from the hydrogen storage tank 11. Accordingly, both the speed of hydrogen release from the hydrogen storage tank 11 and the speed of hydrogen absorption to the MH powder 20 in the hydrogen storage tank 11 can become high compared with the configuration that all hydrogen passes through gaps between particles of the composite of MH powder 20 and aluminum powder 21.

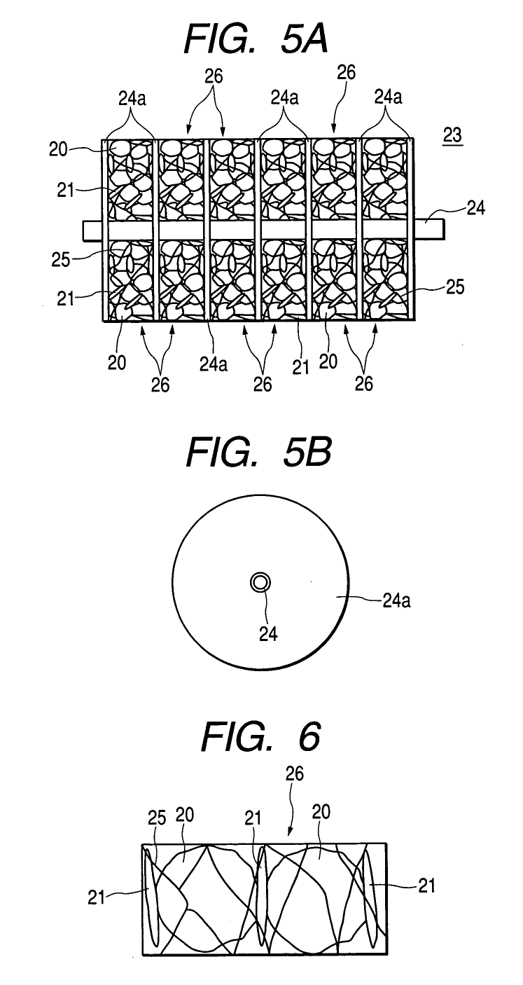

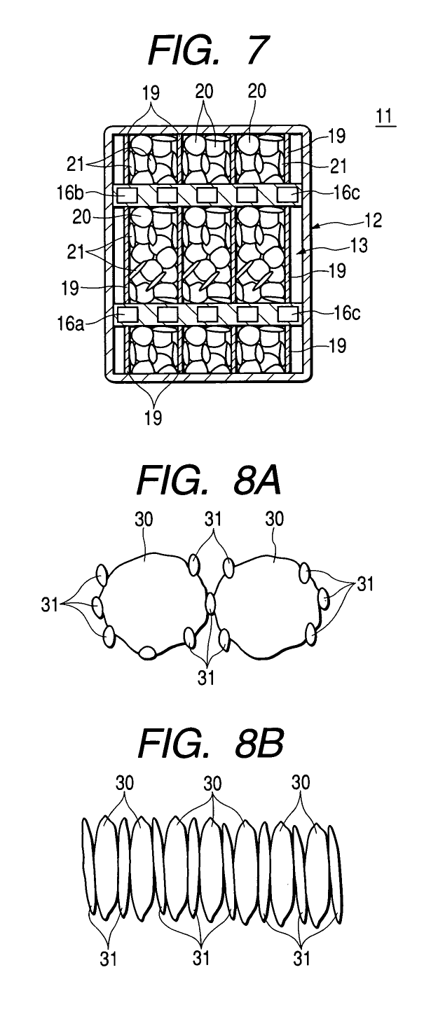

A second embodiment of the invention will be described below with reference to FIGS. 5A, 5B and 6. The second embodiment is different from the first embodiment in the configuration of the heat exchanger and the method for filling (storing) granular MH powder 20. Parts the same as those in the first embodiment are denoted by the same reference numerals as those in the first embodiment, so that detailed description of the parts will be omitted here. Incidentally, FIG. 5A is a typical view showing the relation between the heat exchanger and a hydrogen absorbing alloy molded body. FIG. 5B is a typical side view of the heat exchanger. FIG. 6 is a typical view of each of the hydrogen absorbing alloy molded body molded out of a porous metal molding material after filling the porous metal molding material with the composite of MH powder 20 and flaky aluminum powder 21.

As shown in FIGS. 5A and 5B, the heat exchanger 23 according to this embodiment has a structure in which disk-shaped fins 24a are disposed at regular intervals so as to be protruded around a heat transfer pipe 24. The composite of MH powder 20 and flaky aluminum powder 21 is formed so that the vacant space between adjacent fins 24a is not directly filled with the composite, but hydrogen absorbing alloy molded body 26 each molded into a predetermined shape out of the porous metal molding material (foamed metal) 25 filled with the composite are stored between adjacent fins 24a. The hydrogen absorbing alloy molded body 26 are hereinafter referred to as MH molded body 26. The term “predetermined shape” means a shape suitable for incorporating the MH molded body 26 in the heat exchanger 23. In the second embodiment, because the heat exchanger 23 is formed so that the disk-shaped fins 24a are disposed at regular intervals around the heat transfer pipe 24, each of the MH molded body 26 is shaped like a half column having a semicircular concave portion which can adhere closely to the outer circumference of the heat transfer pipe 24. As shown in FIG. 5A, each pair of MH molded body 26 are disposed between adjacent fins 24a of the heat transfer pipe 24 so that the heat transfer pipe 24 is sandwiched between the pair of MH molded body 26 while the pair of MH molded bodies 26 are in contact with the fins 24a.

As shown in FIG. 6, the porous metal molding material 25 is made of linear metal parts connected to one another three-dimensionally. The voids of the porous metal molding material 25 are filled with the composite of granular MH powder 20 and flaky aluminum powder 21. FIG. 6 typically shows the case where two particles of MH powder 20 and three particles of flaky aluminum powder 21 are enclosed in the metal of the porous metal molding material 25. In practice, the above-described state is continued three-dimensionally. For example, foamed nickel is used as the porous metal molding material 25.

The heat exchanger 23 in which the MH molded bodies 26 are incorporated in the aforementioned manner is received in a bottomed cylindrical housing, to thereby form the hydrogen storage tank 11. The heat exchanger 23 is received in the housing so that opposite end portions of the heat transfer pipe 24 pierce the housing so as to protrude out from the housing. The heat exchanger 23 is used in the condition that the heating medium is supplied from one end of the heat transfer pipe 24 and discharged from the other end of the heat transfer pipe 24.

The second embodiment has the following advantages in addition to the aforementioned advantages (1) and (2) of the first embodiment.

(4) The composite of granular MH powder 20 and flaky aluminum powder 21 is formed as the MH molded body 26. Accordingly, MH powder 20 and flaky aluminum powder 21 can be stored in the housing easily with a good state of heat exchange due to the heat exchanger 23 compared with the case where the vacant space provided in the heat exchanger 23 is directly filled with the composite of MH powder 20 and flaky aluminum powder 21.

(5) The fins 24a are provided so as to protrude from the circumferential surface of the heat transfer pipe 24 in the heat exchanger 23. The MH molded body 26 are disposed so that the heat transfer pipe 24 is clamped by the MH molded bodies 26 in the condition that the MH molded bodies 26 are in contact with adjacent fins 24a. Accordingly, the MH molded bodies 26 can be incorporated in the heat exchanger 23 easily.

(6) The MH molded bodies 26 are formed in such a manner that the porous metal molding material 25 is molded after filled with the composite of granular MH powder 20 and flaky aluminum powder 21. Accordingly, heat transfer efficiency is improved compared with that in the case where the composite is directly molded.

Incidentally, the invention is not limited to the above-described first and second embodiments. For example, the embodiments may be modified as follows.

In the first embodiment, the heat exchanger 13 may be configured so that not only are the fins 19 provided between the two heat transfer pipes 16a and 16b opposite to each other but also the fins 19 are provided on sides opposite to facing surfaces of the two heat transfer pipes 16a and 16b, as shown in FIG. 7. Also in this case, the same advantages as those of the first embodiment can be obtained.

In the first embodiment, the configuration that the upstream side heat transfer pipe 16a and the downstream side heat transfer pipe 16b provided in parallel to each other are connected to each other by the connection pipe 17 so that the heating medium which has passed through the upstream side heat transfer pipe 16a passes through the downstream side heat transfer pipe 16b may be replaced by a configuration that heat transfer pipes are provided in parallel to one another so that the heating medium is supplied to the heat transfer pipes simultaneously from one end side and discharged from the other end side of the heat transfer pipes simultaneously.

Each of the heat transfer pipes 16a and 16b is not limited to the pipe having a large number of independent small flow paths 16c arranged laterally in one row. For example, each of the heat transfer pipes 16a and 16b may be a pipe having a flat flow path.

In the second embodiment, rectangular plate-shaped fins 24a may be provided on both surfaces of the heat transfer pipe 24 so as to protrude from the heat transfer pipe 24 while the heat transfer pipe 24 is formed flatly, so that the MH molded body 26 are disposed between adjacent fins 24a. In this case, each of the MH molded body 26 is formed in a rectangular shape.

The configuration of the heat exchanger 13 or 23 may be replaced by a configuration that the composite of MH powder 20 and flaky aluminum powder 21 or the MH molded body 26 are stored without provision of any fin 19 or 24a in a vacant space formed around each heat transfer pipe 16a, 16b or 24 in the heat exchanger 13 or 23, in which pipe the heating medium flows simply.

MH molded body molded out of the composite of MH powder 20 and flaky aluminum powder 21 without use of the porous metal molding material 25 filled with the composite may be stored in the housing 12.

The porous metal molding material 25 is not limited to nickel (Ni). For example, copper (Cu) or aluminum (Al) may be used as the porous metal molding material 25.

The MH is not limited to a rare-earth alloy (MmNi₅) For example, an Mg—Ni type MH or a Ti—Mn type MH may be used.

In the above-described embodiment, the flaky aluminum powder 21 is used for a heat transfer assisting material. However, the flaky aluminum powder 21 may be replaced by a flaky powder made of any metal material having good characteristic in heat transfer such as copper and nickel.

Three or more heat transfer pipes 16a may be disposed multistageously in the heat exchanger 13.

A plurality of heat exchangers 13 or 23 may be provided in the hydrogen storage tank 11.

The shape of the hydrogen storage tank 11 is not limited to a rectangular parallelepiped shape or a columnar shape.

The hydrogen storage tank 11 is not limited to the case where it is applied to a fuel cell powered electric car. The hydrogen storage tank 11 may be applied to a various apparatus such as a hydrogen source of a hydrogen engine or a heat pump.

The invention (technical thought) grasped from the embodiments will be described below.

(1) In the second embodiment, the fins are provided so as to protrude from the circumferential surface of the heat transfer pipe in the heat exchanger, and the hydrogen absorbing alloy molded body are disposed so that the heat transfer pipe is clamped by the hydrogen absorbing alloy molded body in the condition that the hydrogen absorbing alloy molded body are in contact with adjacent fins.

(2) In the embodiments, the composite of the hydrogen absorbing alloy powder and flaky aluminum powder is molded into a predetermined shape.

(3) A heat pump having a hydrogen storage tank according to any one of the embodiments and the above technical thoughts (1) and (2).

As described above in detail, according to the invention, the hydrogen absorbing/releasing speed increases, so that the hydrogen releasing response of the hydrogen storage tank can be quickened while the time required for filling the hydrogen storage tank with hydrogen can be shortened.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A hydrogen storage tank comprising:
a housing; and
a composite contained in the housing, the composite including a granular hydrogen absorbing alloy powder and a flaky metal powder.

2. The hydrogen storage tank as claimed in claim 1, wherein the flaky metal powder is made of aluminum.

3. The hydrogen storage tank as claimed in claim 1, further comprising a heat exchanger having a fin,
wherein the composite is accommodated in the housing to be in contact with the fin.

4. The hydrogen storage tank as claimed in claim 1, further comprising:
a heat exchanger having a fin; and
a hydrogen absorbing alloy molded body molded out of a porous metal molding in which the composite is filled in voids thereof,
wherein the hydrogen absorbing alloy molded body is accommodated in the housing to be in contact with the fin.

5. The hydrogen storage tank as claimed in claim 1, wherein the granular hydrogen absorbing alloy comprises a rare-earth alloy having a particle size no larger than 500 μm.

6. The hydrogen storage tank as claimed in claim 5, wherein the granular hydrogen absorbing alloy comprises a MmNi₅ alloy.

7. The hydrogen storage tank as claimed in claim 1, wherein the flaky metal powder has a mean particle size of 80 μm and a thickness in a range of from 0.5 μm to 2.0 μm.

8. The hydrogen storage tank as claimed in claim 7, wherein the flaky metal powder is composed within the composite in amount in a range of from 2% by volume to 11% by volume.

9. The hydrogen storage tank as claimed in claim 8, wherein the flaky metal powder is composed within the composite in amount in a range of from 3.5% by volume to 10% by volume.

10. The hydrogen storage tank as claimed in claim 4, wherein the porous metal molding is formed of at least one of Ni, Cu and Al.

11. The hydrogen storage tank as claimed in claim 1, wherein the granular hydrogen absorbing alloy comprises at least one of MmNi₅alloy, Mg—Ni type alloy and a Ti—Mn type alloy.

12. A hydrogen absorbing alloy molded body comprising:
a porous metal molding;
a composite including a granular hydrogen absorbing alloy powder and a flaky metal powder filled within the porous metal molding.
